(19) United States
(12) Patent Application Publication
(10) Pub. No.: US 2012/0299496 A1
(43) Pub. Date: Nov. 29, 2012

(54) CONSTANT POWER SUPPLY CONVERTER FOR AN LED MODULE

(76) Inventor: Jong-Man Eun, Goyang-si (KR)

(21) Appl. No.: 13/576,421

(22) PCT Filed: Feb. 1, 2011
(86) PCT No.: PCT/KR2011/000726

§ 371 Date: Aug. 1, 2012

(30) Foreign Application Priority Data
Feb. 2, 2010 (KR) 10-2010-0009735

(51) Int. Cl. H05B 37/02

(52) U.S. Cl. 315/201

(57) ABSTRACT

The present invention relates to a power supply apparatus for an LED light source, in which the power supply apparatus for supplying driving power to a high efficiency LED light source has a power factor compensating function that improves power efficiency. To accomplish this, the power supply apparatus for an LED light source according to the present invention comprises a power factor compensation control circuit which includes a step-up transformer, and which compensates for a power factor of commercial alternating current power and outputs power; a charging capacitor, in which the power output from the power factor compensation control circuit is stored; a resonant switching circuit which switches power output from the charging capacitor, and supplies the voltage level required by a load side; a rectifying circuit which rectifies the voltage output from the resonant switching circuit into a predetermined direct current voltage; an LED power switching circuit which switches the voltage rectified by the rectifying circuit, and supplies the switched voltage to the load side; a voltage control circuit which senses the voltage output from the rectifying circuit, and controls a switching frequency of the resonant switching circuit to control the size of the voltage output from the rectifying circuit; and an oscillation circuit which supplies oscillation output to the LED power switching circuit to switch the supplied output by a predetermined frequency.

### TECHNICAL FIELD

The present invention relates to a constant power supply converter for an LED module used to supply driving power to a high-efficiency LED light source, and more particularly, to a constant power supply converter for an LED module that has a power factor compensating function to improve power efficiency.

### BACKGROUND ART

For many years, a lamp adopting a filament has been used, but the lamp adopting the filament emits most energy thereof as heat and uses some of the emitted energy as light, which have low thermal efficiency.

Therefore, in recent years, a light emitting diode (LED) has been developed, which has lower power consumption, longer in life-span thereof, and brighter and clearer than the existing incandescent lamp to be used in various fields such as a signal lamp, a lighting stand, a signboard, a flashlight, a small-sized lamp, and the like.

The LED device is manufactured and sold as various lamps of an indoor illumination while being gradually developed to a higher luminance LED device, and a plurality of light emitting diodes are arranged vertically and horizontally or one or a plurality of high-luminance light emitting diodes are arranged to be used as one light source in order to acquire appropriate brightness when the LED device is used as the indoor illumination.

The LED device as a light source using a luminous phenomenon which occurs when voltage is applied to a semiconductor uses DC power as driving power.

However, in general, since commercial power is configured by 220V AC power, the commercial power needs to be appropriately converted to be converted into a voltage level required by the LED light source, and moreover, needs to be supplied with high power efficiency.

### DISCLOSURE

### Technical Problem

The present invention has been made to solve the problem and an object of the present invention is to provide a constant power supply converter for an LED module that switches power acquired by compensating a power factor of commercial AC power at a predetermined cycle and supplies the switched power to an LED light source to supply power with an improved power factor to the LED light source.

### Technical Solution

A constant power supply converter for an LED module includes: a power factor compensation control circuit that includes a step-up transformer to compensate and output a power factor of commercial AC power; a charging condenser that stores the output power of the power factor compensation control circuit; a resonant switching circuit that switches output power of the charging condenser and supplies the switched output power to voltage at a level requested from a load side; a rectifying circuit that rectifies output voltage of the resonant switching circuit to a predetermined DC voltage; an LED power switching circuit that switches the rectified voltage of the rectifying circuit and supplies the switched rectified voltage to the load side; a voltage control circuit that senses the output voltage of the rectifying circuit and controls a switching frequency of the resonant switching circuit to control the magnitude of the output voltage of the rectifying circuit; and an oscillating circuit that supplies an oscillation output to the LED power switching circuit and switches the supplied oscillation output at a predetermined frequency.

A temperature compensation circuit controlling output voltage of a voltage control circuit by sensing a temperature change of an LED load may be connected to one end of the voltage control circuit.

### Advantageous Effects

The power supply device for the LED light source according to the present invention can supply power with the improved power factor to the LED light source to improve power efficiency.

### DESCRIPTION OF DRAWINGS

FIG. 1 illustrates a circuit diagram of the present invention.

### BEST MODE

Hereinafter, a configuration and an operation of an exemplary embodiment of the present invention will be described in detail with reference to the accompanying drawings.

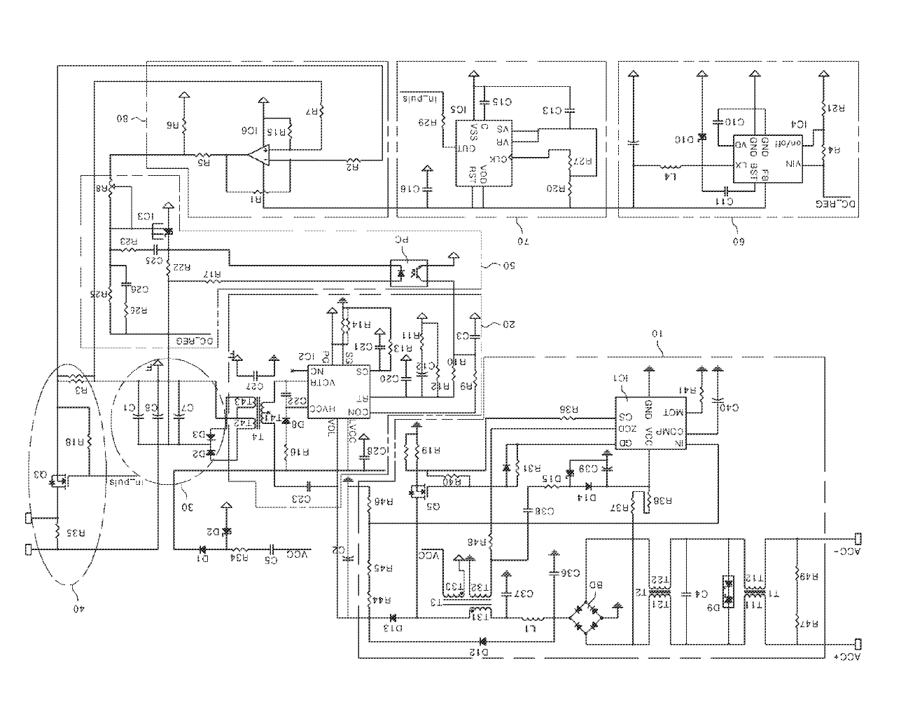

FIG. 1 illustrates a circuit diagram for implementing a constant power supply converter for an LED module according to the present invention.

A power factor compensation control circuit 10 serves to receive commercial AC power, and compensates a power factor with respect to the received power to output the power with the compensated power factor.

In the power factor compensation control circuit 10, one coil of each of a transformer T1 and a transformer T2 configured in two stages is, in series, connected to one power line of commercial power and the other one coil of each of the transformer T1 and the transformer T2 is, in series, connected to the other one power line of the commercial power, and a bridge diode (BD) is connected to both coil output sides of the transformer T2.

A primary coil T31 of a step-up transformer T3 is connected to an output side of the bridge diode (BD) through a coil L1, a zero current detecting terminal of a power factor compensation IC IC1 is connected to a secondary coil T32 of the transformer T3, a drain of an FET Q5 is connected to an output side of the primary coil T31 of the transformer T3, and as a result, a gate and a source thereof are connected to a totem pole driving output terminal of the power factor compensation IC IC1 and an input terminal of an overcurrent protection comparator, respectively. An output terminal of the transformer T2 is connected to a driving power terminal of the power factor compensation IC IC1.

A Vcc power terminal is provided at a tertiary coil T33 of the transformer T3.

A charging condenser C2 is connected to an output side of the primary coil T31 of the step-up transformer T3 through a reverse flow prevention diode D13.

An inversion input terminal of an error amplifier in the power factor compensation IC IC1 is connected to an output terminal of the reverse flow prevention diode D13 through division resistors R44 to R46.

The power factor compensation control circuit 10 full-wave rectifies the commercial power by controlling the FET Q5 of the power factor compensation IC IC1 and thereafter, steps up the full-wave rectified commercial power in the transformer T3 and charges the stepped-up power in the condenser C2.

The power charged in the condenser C2 charges a rectifying circuit 30 by switching a resonant switching circuit 20.

In the resonant switching circuit 20, one end of a primary coil T41 of a transformer T4 is connected to the charging condenser C2 and the other end of the primary coil T41 of the transformer T4 is connected to a lower MOSFET drain terminal VCTR of a half bridge resonant converter power switch IC2.

An output side of the charging condenser C2 is connected to an upper MOSFET drain terminal VDL of the power switch IC2.

The rectifying circuit 30 constituted by condensers C7, C8, and C1 is connected to a secondary coil T42 and a tertiary coil T43 of the transformer T4 through rectifying diodes D2 and D3, respectively.

Therefore, the voltage charged in the charging condenser C2 by a switching operation of the power switch IC2 is induced to the secondary coil T42 and the tertiary coil T43 of the transformer T4 by an inducing operation of the transformer T4 to be rectified by the rectifying diodes D2 and D3, respectively, and thereafter, charged in the condensers C7, C8, and C1. In this case, the transformer T4 serves to reduce the voltage of the charging condenser C2 to a predetermined voltage level required to drive the LED light source connected to a load side.

And, a load is connected to an output side of the rectifying circuit 30 through an LED power switching circuit 40 including an FET Q3 which is a switching device.

Moreover, a voltage control circuit 50 for controlling voltage of power supplied from the LED power switching circuit 40 to the load side is connected between the output side of the rectifying circuit 30 and a control terminal of the resonant switching circuit 20.

In the voltage control circuit 50, a resistor R22 and a programmable shunt regulator IC3 are connected to the output side of the rectifying circuit 30, and both ends of a photodiode of a photocoupler PC are connected to both ends of the resistor R22 and a switching frequency control terminal RT of the power switch IC2 is connected to an output side of a phototransistor of the photocoupler PC. Division voltage by a resistor R25, a variable resistor R8, and a resistor R6 that are connected between the output side of the rectifying circuit 30 and a ground is inputted into a reference voltage input terminal of the programmable shunt regulator IC3.

Therefore, when the voltage supplied to the load side from the rectifying circuit 30 through the LED power switching circuit 40 fluctuates, reference voltage of the programmable shunt regulator IC3 fluctuates, and the fluctuation of the reference voltage causes a switching frequency of the power switch IC2 to vary through the photocoupler PC to continuously output predetermined voltage in the LED power switching circuit 40.

That is, when the voltage supplied to the load side from the LED power switching circuit 40 is higher than the set voltage, the voltage supplied to the reference voltage terminal of the programmable shunt regulator IC3 is higher than the set voltage, such that current flows on the photodiode of the photocoupler PC, and as a result, the phototransistor of the photocoupler PC is turned on. Such that, current flows on the switching frequency control terminal RT of the power switch IC2 to turn off a switching device in the power switch IC2, thereby interrupting the voltage inducing operation of the transformer T4. Therefore, as the output voltage of the rectifying circuit 30 decreases, the set voltage is maintained.

Thereafter, when the output voltage of the rectifying circuit 30 is lower than the set voltage, the voltage inputted into the control terminal of the programmable shunt regulator IC3 also decreases to interrupt the programmable shunt regulator IC3, and as a result, an operation of the photocoupler PC is also interrupted, such that the voltage inducing operation of the transformer T4 depending on an operation of the power switch IC2 restarts.

Meanwhile, an oscillation means for controlling the power supplied to the LED light source of the load side from the LED power switching circuit 40 by controlling switching of the FET Q3 is provided at a gate of the FET Q3 which is the switching device in the LED power switching circuit 40.

The oscillation means includes a constant voltage circuit 60 that receives DC voltage from the rectifying circuit 30 and outputs predetermined DC voltage, and an oscillating circuit 70 that receives the output voltage of the constant voltage circuit 60 and outputs a pulse signal of a predetermined cycle.

The constant voltage circuit 60 includes a step-down converter IC4 and the step-down converter IC4 is a DC-DC converter IC.

Further, in the oscillating circuit 70, an output frequency of a timer IC IC5 varies depending on a time constant by resistors R20 and R27, and a condenser C13, and a pulse signal outputted from the timer IC IC5 is applied to the gate of the FET Q3 which is a switching device in the LED power switching circuit 40 to control switching of the FET Q3.

The FET Q3 cyclically controls the power supplied to the LED light source at the load side from the LED power switching circuit 40 to maximize power efficiency without influencing illumination.

Moreover, a temperature compensation circuit 80 may be additionally connected to a source side of the FET Q3 in the LED power switching circuit 40.

The temperature compensation circuit 80 has a structure in which a temperature sensing device R3 is connected to the source side of the FET Q3, such that one end of the temperature sensing device R3 connected to the source side of the FET Q3 is connected to an inverse terminal of an amplifier IC6 and the other end of the temperature sensing device R3 is connected to a non-inverse terminal of the amplifier IC6, and an output side of the amplifier IC6 is connected to a base terminal of a variable resistor R8 connected to the control terminal of the programmable shunt regulator IC3 in the voltage control circuit 50.

As a result, when a temperature is changed in the LED light source, a resistance value of the temperature sensing device R3 is changed. Therefore, the output of the amplifier IC6 is changed, and the voltage applied to the control terminal of the programmable shunt regulator IC3 is changed, such that voltage supplied to the load side from the LED power switching circuit 40 is controlled to the set voltage through the rectifying circuit 30 based on the operation of the power switch IC2 described above.

Therefore, although the load of the output side increases due to the increase in temperature of the LED light source, excessive voltage is prevented from being outputted to the load side.

### INDUSTRIAL APPLICABILITY

The constant power supply converter for the LED module according to the present invention is applied to an illumination device using an LED as a light source to improve power efficiency.

1. A constant power supply converter for an LED module, comprising:
a power factor compensation control circuit that includes a step-up transformer to compensate and output a power factor of commercial AC power;
a charging condenser that stores the output power of the power factor compensation control circuit;
a resonant switching circuit that switches the output power of the charging condenser and supplies the switched the output power to voltage at a level requested from a load side;
a rectifying circuit that rectifies the output voltage of the resonant switching circuit to predetermined DC voltage;
an LED power switching circuit that switches the rectified voltage of the rectifying circuit and supplies the switched rectified voltage to the load side;
a voltage control circuit that senses the output voltage of the rectifying circuit and controls a switching frequency of the resonant switching circuit to control the magnitude of the output voltage of the rectifying circuit; and
an oscillating circuit that supplies an oscillation output to the LED power switching circuit and switches the supplied oscillation output at a predetermined frequency.

2. The constant power supply converter for an LED module of claim 1, wherein a temperature compensation circuit controlling output voltage of a voltage control circuit by sensing a temperature change of an LED load is connected to one end of the voltage control circuit.
